(19) United States
(12) Patent Application Publication
(10) Pub. No.: US 2022/0234653 A1
(43) Pub. Date: Jul. 28, 2022

(54) VEHICLE COLLISION AVOIDANCE ASSIST APPARATUS

(71) Applicants: TOYOTA JIDOSHA KABUSHIKI KAISHA, Toyota-shi (JP); DENSO CORPORATION, Kariya-city (JP)

(72) Inventors: Mafune KAKESHITA, Toyota-shi (JP); Yumi SHIMANAKA, Kasugai-shi (JP); Sho HASHIMOTO, Sunto-gun (JP); Karin MORITA, Kariya-city (JP)

(73) Assignees: TOYOTA JIDOSHA KABUSHIKI KAISHA, Toyota-shi (JP); DENSO CORPORATION, Kariya-city (JP)

(21) Appl. No.: 17/577,819

(22) Filed: Jan. 18, 2022

(30) Foreign Application Priority Data
Jan. 25, 2021 (JP) 2021-009412

(51) Int. Cl. B62D 15/02

(52) U.S. Cl. CPC B62D 15/0265

(57) ABSTRACT

A vehicle collision avoidance assist apparatus executes a steering avoidance control of setting an avoidance route for avoiding the collision of the own vehicle with the object in a lane in which the own vehicle moves and executing an avoiding steering process of forcibly steering the own vehicle so as to move the own vehicle along the avoidance route when an index value representing a probability of collision of an own vehicle with an object ahead of the own vehicle becomes equal to or greater than a predetermined index value. The apparatus stops executing the steering avoidance control when the object is a moving object which moves in the same direction as a moving direction of the own vehicle, and a deceleration of the moving object becomes equal to or greater than a predetermined deceleration.

### BACKGROUND

### Field

The invention relates to a vehicle collision avoidance assist apparatus.

### Description of the Related Art

There is known a vehicle collision avoidance assist apparatus which executes a forcibly braking control of forcibly braking and stopping an own vehicle to avoid collision of the own vehicle with an object ahead of the own vehicle when the own vehicle probably collides with the object. Also, there is known a vehicle collision avoidance assist apparatus which executes a steering avoidance control of forcibly steering the own vehicle to avoid the object to avoid the collision of the own vehicle with the object when the vehicle collision avoidance assist apparatus predicts that the own vehicle cannot avoid the collision with the object even by forcibly braking the own vehicle (for example, see JP 2017-43262 A).

While the known vehicle collision avoidance assist apparatus executes the steering avoidance control, the known vehicle collision avoidance assist apparatus sets an avoidance route along which the known vehicle collision avoidance assist apparatus moves the own vehicle, avoiding the object and steers the own vehicle to move along the avoidance route. However, when the object ahead of the own vehicle is a moving object such as a preceding vehicle which moves in the same direction as a moving direction of the own vehicle, the moving object may be decelerated after the known vehicle collision avoidance assist apparatus starts moving the own vehicle along the avoidance route. In this case, the own vehicle may rapidly approach the moving object, and the avoidance route may become close to or cross the moving object. If an execution of the steering avoidance control is continued when the own vehicle rapidly approaches the moving object, and the avoidance route becomes close to or crosses the moving object, the own vehicle may collide with the moving object.

### SUMMARY

An object of the invention is to provide a vehicle collision avoidance assist apparatus which can prevent collision of the own vehicle with the moving object when the moving object is decelerated while the vehicle collision avoidance assist apparatus executes the steering avoidance control.

According to the invention, a vehicle collision avoidance assist apparatus comprises an electronic control unit configured to execute a steering avoidance control. The steering avoidance control is a control of setting an avoidance route for avoiding the collision of the own vehicle with the object in a lane in which the own vehicle moves, and executing an avoiding steering process of forcibly steering the own vehicle so as to move the own vehicle along the avoidance route, when an index value representing a probability of collision of an own vehicle with an object ahead of the own vehicle becomes equal to or greater than a predetermined index value. The electronic control unit is configured to stop executing the steering avoidance control when (i) the object is a moving object which moves in the same direction as a moving direction of the own vehicle, and (ii) a deceleration of the moving object becomes equal to or greater than a predetermined deceleration.

When the object with which the own vehicle is avoiding the collision, is the moving object, and the moving object is decelerated, the own vehicle may rapidly approach the moving object, and the avoidance route may become close to or cross the moving object. If the execution of the steering avoidance control is continued after the avoidance route becomes close to or cross the moving object, the own vehicle may collide with the moving object. According to the invention, when the moving object is decelerated, and the deceleration of the moving object becomes equal to or greater than the predetermined deceleration while the steering avoidance control is executed, the execution of the steering avoidance control is stopped. Thus, the own vehicle can be prevented from colliding with the moving object even when the moving object is decelerated.

According to an aspect of the invention, the avoidance route may be set, based on a relative moving speed of the own vehicle with respect to the moving object at a point of time when the index value becomes equal to or greater than the predetermined index value.

When the moving object is decelerated, the relative moving speed of the own vehicle with respect to the moving object is increased. Thus, if the avoidance route is set, based on the relative moving speed of the own vehicle with respect to the moving object at the point of time when the index value becomes equal to or greater than the predetermined index value, whether the moving object is decelerated or not considerably influences whether the own vehicle collides with the moving object when the own vehicle is moved along the avoidance route. According to this aspect of the invention, the avoidance route is set, based on the relative moving speed of the own vehicle with respect to the moving object. Then, when the deceleration of the moving object becomes equal to or greater than the predetermined deceleration, the execution of the steering avoidance control is stopped. Thus, the own vehicle can be surely prevented from colliding with the moving object.

According to another aspect of the invention, the index value may be a predicted reaching time which is a time predictively taken for the own vehicle to reach the object. In this aspect, the index value may increase as the predicted reaching time decreases. Further, in this aspect, the predicted reaching time may be acquired, based on (i) a distance between the own vehicle and the object and (ii) a relative moving speed of the own vehicle with respect to the object. Furthermore, the steering avoidance control may be executed when the predicted reaching time becomes a predetermined predicted reaching time which corresponds to the predetermined index value.

In order to execute the steering avoidance control with preventing an unnecessary execution of the steering avoidance control, it is effective to determine a timing of starting the execution of the steering avoidance control, based on the time taken for the own vehicle to reach the object. With this aspect of the invention, whether the execution of the steering avoidance control should be started, is determined, based on the time predictively taken for the own vehicle to reach the object (i.e., the predicted reaching time) as the index value. Thus, the steering avoidance control can be executed with preventing the unnecessary execution of the steering avoidance control.

Elements of the invention are not limited to elements of embodiments and modified examples of the invention described with reference to the drawings. The other objects, features and accompanied advantages of the invention can be easily understood from the embodiments and the modified examples of the invention.

### BRIEF DESCRIPTION OF THE DRAWINGS

FIG. 1 is a view which shows a vehicle collision avoidance assist apparatus according to an embodiment of the invention and an own vehicle on which the vehicle collision avoidance assist apparatus according to the embodiment of the invention is installed.

FIG. 2A is a view which shows lane markings which define a lane in which the own vehicle moves.

FIG. 2B is a view which shows a yaw angle of the own vehicle.

FIG. 2C is a view which shows the yaw angle of the own vehicle.

FIG. 3A is a view which shows an own vehicle moving area.

FIG. 3B is a view which shows a scene that a vehicle as an object is in the own vehicle moving area.

FIG. 3C is a view which shows a recommended avoidance route along which the own vehicle is moved to avoid the vehicle as the object.

FIG. 3D is a view which shows a target avoidance route along which the own vehicle is moved to avoid the vehicle as the object.

FIG. 4A is a view which shows a scene that an execution of a steering process or an avoiding steering process of steering the own vehicle to move the own vehicle along the avoidance route, is started.

FIG. 4B is a view which shows a scene that the avoiding steering process is being executed.

FIG. 4C is a view which shows a scene that an execution of a steering avoidance control is terminated.

FIG. 5A is a view which shows a scene that the execution of the steering process or the avoiding steering process of steering the own vehicle to move the own vehicle along the avoidance route is started.

FIG. 5B is a view which shows a situation which may occur if the execution of the avoiding steering process or the steering avoidance control is continued when a preceding vehicle as the object ahead of the own vehicle is decelerated, the own vehicle rapidly approaches the preceding vehicle as the object, and the avoidance route becomes close to or crosses the preceding vehicle as the object.

FIG. 6 is a view which shows a time chart which illustrates changes of a deceleration of a target moving object, etc. when the execution of the steering avoidance control is not terminated without the execution of the steering avoidance control being stopped halfway.

FIG. 7 is a view which shows a time chart which illustrates the changes of the deceleration of the target moving object, etc. when the execution of the steering avoidance control is stopped halfway.

FIG. 8 is a view which shows a flowchart of a routine executed by the vehicle collision avoidance assist apparatus according to the embodiment of the invention.

### DESCRIPTION OF THE EMBODIMENTS

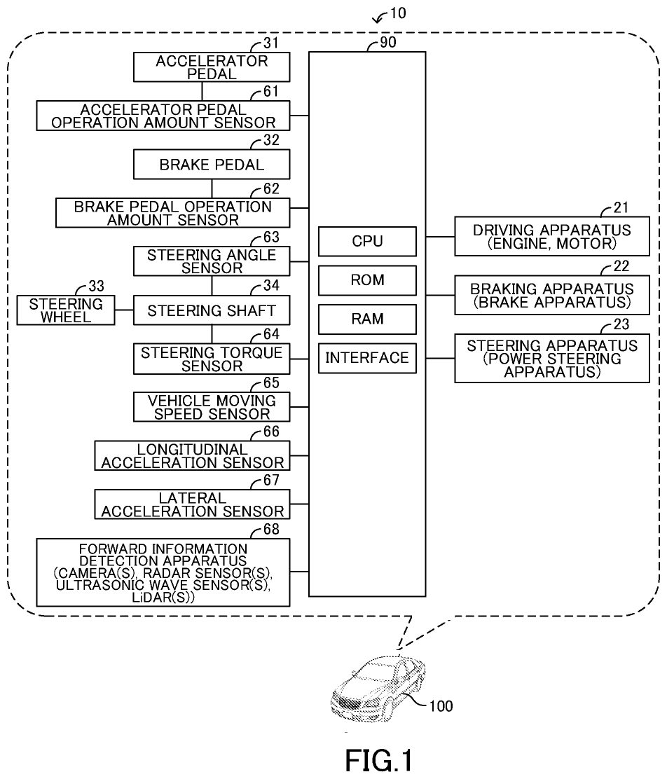

Below, a vehicle collision avoidance assist apparatus according to an embodiment of the invention will be described with reference to the drawings. As shown in FIG. 1, the vehicle collision avoidance assist apparatus 10 according to the embodiment of the invention is installed on an own vehicle 100.

<ECU>

As shown in FIG. 1, the vehicle collision avoidance assist apparatus 10 includes an ECU 90. ECU stands for electronic control unit. The ECU 90 includes a micro-computer as a main component. The micro-computer includes a CPU, a ROM, a RAM, a non-volatile, and an interface. The CPU is configured or programmed to realize various functions by executing instructions, programs, or routines stored in the ROM.

<Driving Apparatus, Etc.>

Moreover, a driving apparatus 21, a braking apparatus 22, and a steering apparatus 23 are installed on the own vehicle 100.

<Driving Apparatus>

The driving apparatus 21 is an apparatus which outputs a driving force to be applied to the own vehicle 100 to move the own vehicle 100. The driving apparatus 21 is, for example, an internal combustion engine and at least one electric motor. The driving apparatus 21 is electrically connected to the ECU 90. The ECU 90 can control the driving force output from the driving apparatus 21 by controlling an activation of the driving apparatus 21.

<Braking Apparatus>

The braking apparatus 22 is an apparatus which outputs a braking force to be applied to the own vehicle 100 to brake the own vehicle 100. The braking apparatus 22 is, for example, a brake apparatus. The braking apparatus 22 is electrically connected to the ECU 90. The ECU 90 can control the braking force output from the braking apparatus 22 by controlling an activation of the braking apparatus 22.

<Steering Apparatus>

The steering apparatus 23 is an apparatus which outputs a steering force to be applied to the own vehicle 100 to steer the own vehicle 100. The steering apparatus 23 is, for example, a power steering apparatus. The steering apparatus 23 is electrically connected to the ECU 90. The ECU 90 can control the steering force output from the steering apparatus 23 by controlling an activation of the steering apparatus 23.

<Sensors, Etc.>

Moreover, an accelerator pedal operation amount sensor 61, a brake pedal operation amount sensor 62, a steering angle sensor 63, a steering torque sensor 64, a vehicle moving speed sensor 65, a longitudinal acceleration sensor 66, a lateral acceleration sensor 67, and a forward information detection apparatus 68.

<Accelerator Pedal Operation Amount Sensor>

The accelerator pedal operation amount sensor 61 is electrically connected to the ECU 90. The accelerator pedal operation amount sensor 61 detects an operation amount of an accelerator pedal 31. The accelerator pedal operation amount sensor 61 sends information on the detected operation amount to the ECU 90. The ECU 90 acquires the operation amount of the accelerator pedal 31 as an accelerator pedal operation amount AP, based on the information sent from the accelerator pedal operation amount sensor 61. The ECU 90 calculates and acquires a requested driving force PDreq, based on the accelerator pedal operation amount AP and a vehicle moving speed V100 of the own vehicle 100. The requested driving force PDreq is a driving force requested for the driving apparatus 21 to output.

<Brake Pedal Operation Amount Sensor>

The brake pedal operation amount sensor 62 is electrically connected to the ECU 90. The brake pedal operation amount sensor 62 detects an operation amount of a brake pedal 32. The brake pedal operation amount sensor 62 sends information on the detected operation amount to the ECU 90. The ECU 90 acquires the operation amount of the brake pedal 32 as a brake pedal operation amount BP, based on the information sent from the brake pedal operation amount sensor 62. The ECU 90 calculates and acquires a requested braking force PBreq, based on the brake pedal operation amount BP. The requested braking force PBreq is a braking force requested for the braking apparatus 22 to output.

<Steering Angle Sensor>

The steering angle sensor 63 is electrically connected to the ECU 90. The steering angle sensor 63 detects a rotation angle of a steering wheel 33 of the own vehicle 100 from a neutral position of the steering wheel 33. The steering angle sensor 63 sends information on the detected rotation angle to the ECU 90. The ECU 90 acquires the rotation angle of the steering wheel 33 from the neutral position as a steering angle SA, based on the information sent from the steering angle sensor 63.

<Steering Torque Sensor>

The steering torque sensor 64 is electrically connected to the ECU 90. The steering torque sensor 64 detects a torque which a driver of the own vehicle 100 inputs to a steering shaft 34 via the steering wheel 33. The steering torque sensor 64 sends information on the detected torque to the ECU 90. The ECU 90 acquires the torque which the driver inputs to the steering shaft 34 via the steering wheel 33 as a driver input torque TQdr, based on the information sent from the steering torque sensor 64.

<Vehicle Moving Speed Sensor>

The vehicle moving speed sensor 65 is electrically connected to the ECU 90. The vehicle moving speed sensor 65 detects rotation speeds of wheels of the own vehicle 100. The vehicle moving speed sensor 65 sends information on the detected rotation speeds of the wheels of the own vehicle 100. The ECU 90 acquires the moving speed of the own vehicle 100 as the vehicle moving speed V100, based on the information sent from the vehicle moving speed sensor 65.

In addition, the ECU 90 calculates and acquires a torque to be applied to the steering shaft 34 from the steering apparatus 23 as an assist steering torque TQas, based on the driver input torque TQdr and the vehicle moving speed V100. The assist steering torque TQas is a torque applied to the steering shaft 34 to assist a steering operation to the steering wheel 33 carried out by the driver.

<Longitudinal Acceleration Sensor>

The longitudinal acceleration sensor 66 is electrically connected to the ECU 90. The longitudinal acceleration sensor 66 detects an acceleration of the own vehicle 100 in a longitudinal direction of the own vehicle 100. The longitudinal acceleration sensor 66 sends information on the detected acceleration to the ECU 90. The ECU 90 acquires the acceleration of the own vehicle 100 in the longitudinal direction of the own vehicle 100 as a longitudinal acceleration Gx, based on the information sent from the longitudinal acceleration sensor 66.

<Lateral Acceleration Sensor>

The lateral acceleration sensor 67 is electrically connected to the ECU 90. The lateral acceleration sensor 67 detects an acceleration of the own vehicle 100 in a lateral direction of the own vehicle 100. The lateral acceleration sensor 67 sends information on the detected acceleration to the ECU 90. The ECU 90 acquires the acceleration of the own vehicle 100 in the lateral direction of the own vehicle 100 as a lateral acceleration Gy, based on the information sent from the lateral acceleration sensor 67.

<Forward Information Detection Apparatus>

The forward information detection apparatus 68 is an apparatus which detects information on a situation ahead of the own vehicle 100. The forward information detection apparatus 68 includes, for example, at least one camera, at least one radar sensor such as at least one millimeter wave radar, at least one ultrasonic wave sensor such as at least one clearance sonar, and at least one laser radar such as at least one LiDAR.

The forward information detection apparatus 68 is electrically connected to the ECU 90. The forward information detection apparatus 68 detects information on the situation ahead of the own vehicle 100. The forward information detection apparatus 68 sends the detected information (forward information I_F) to the ECU 90.

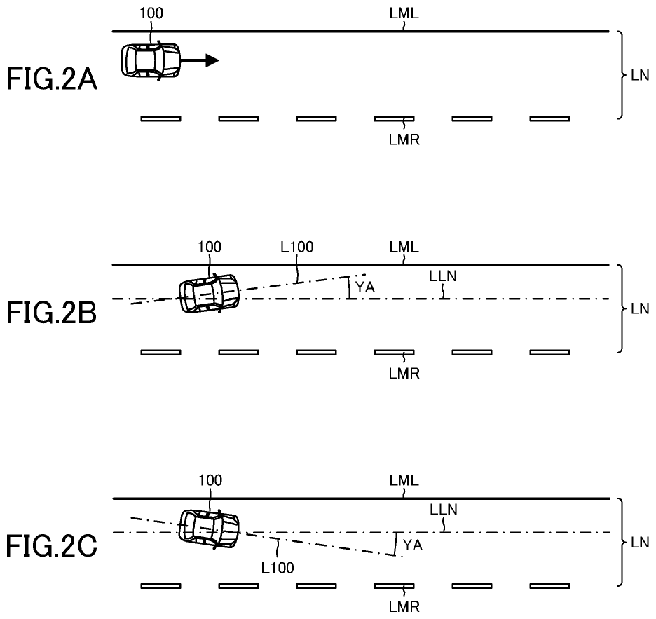

The ECU 90 can detect an object 200 ahead of the own vehicle 100, based on the forward information I_F. Moreover, when the ECU 90 detects the object 200, the ECU 90 can acquire an object distance D200, a relative moving speed dV, and a moving direction of the object 200, based on the forward information I_F. The object distance D200 is a distance between the object 200 and the own vehicle 100. The relative moving speed dV is a relative moving speed of the own vehicle 100 with respect to the object 200. In addition, the ECU 90 can recognize a left lane marking LML and a right lane marking LMR (see FIG. 2A) which define an own vehicle moving lane LN, based on the forward information I_F. The own vehicle moving lane LN is a moving lane of the own vehicle 100. Otherwise, the ECU 90 can recognize an end of a road on which the own vehicle 100 moves, based on the forward information I_F. That is, the ECU 90 can recognize a road end, based on the forward information I_F.

Then, the ECU 90 acquires a yaw angle YA, based on the recognized left and right lane markings LML and LMR or the recognized road end. As shown in FIG. 2B and FIG. 2C, the yaw angle YA is an angle between an own vehicle moving lane extending direction line LLN and an own vehicle longitudinal extending center line L100. The own vehicle moving lane extending direction line LLN is a line which represents an extending direction of the own vehicle moving lane LN. The own vehicle longitudinal extending center line L100 is a line which extends through a center of a width of the own vehicle 100 in the longitudinal direction of the own vehicle 100.

<Summary of Operations of Vehicle Collision Avoidance Assist Apparatus>

Next, a summary of operations of the vehicle collision avoidance assist apparatus 10 will be described. While the own vehicle 100 moves, the vehicle collision avoidance assist apparatus 10 determines, based on the forward information I_F, whether there is an object ahead of the own vehicle 100. In this embodiment, the object is a vehicle, a person, a bicycle, or a guard rail.

When there is an object ahead of the own vehicle 100, and a probability that the own vehicle 100 collides with the object has been increased to a high level, the vehicle collision avoidance assist apparatus 10 determines whether there is space at the side of the object where the own vehicle 100 can move and avoid the object. When there is the space, the vehicle collision avoidance assist apparatus 10 executes a steering avoidance control of steering the own vehicle 100 to avoid the object, using the space.

It should be noted that the vehicle collision avoidance assist apparatus 10 may be configured to execute an alerting process of informing the driver of the own vehicle 100 that the own vehicle 100 may collide with the object before the vehicle collision avoidance assist apparatus 10 starts an execution of the steering avoidance control. In this case, when the driver does not carry out an operation of avoiding the collision of the own vehicle 100 with the object such as an operation to the accelerator pedal 31, an operation to the brake pedal 32, and an operation to the steering wheel 33 even by executing the alerting process, the vehicle collision avoidance assist apparatus 10 executes a forcibly braking process of forcibly braking the own vehicle 100 to stop the own vehicle 100. In this case, when the own vehicle 100 probably collides with the object even by executing the forcibly braking process, the vehicle collision avoidance assist apparatus 10 executes the steering avoidance control.

Further, the vehicle collision avoidance assist apparatus 10 executes a normal moving control when there is no object ahead of the own vehicle 100 or when there is the object ahead of the own vehicle 100 but the vehicle collision avoidance assist apparatus 10 predicts that the own vehicle 100 does not collide with the object. The normal moving control is a control of controlling the activation of the driving apparatus 21 to cause the driving apparatus 21 to output the driving force corresponding to the requested driving force PDreq when the requested driving force PDreq is greater than zero. In addition, the normal moving control is a control of controlling the activation of the braking apparatus 22 to cause the braking apparatus 22 to output the braking force corresponding to the requested braking force PBreq when the requested braking force PBreq is greater than zero. In addition, the normal moving control is a control of controlling the activation of the steering apparatus 23 to cause the steering apparatus 23 to output the steering torque corresponding to the assist steering torque TQas when the assist steering torque TQas is greater than zero.

<Steering Avoidance Control>

Next, the steering avoidance control will be described.

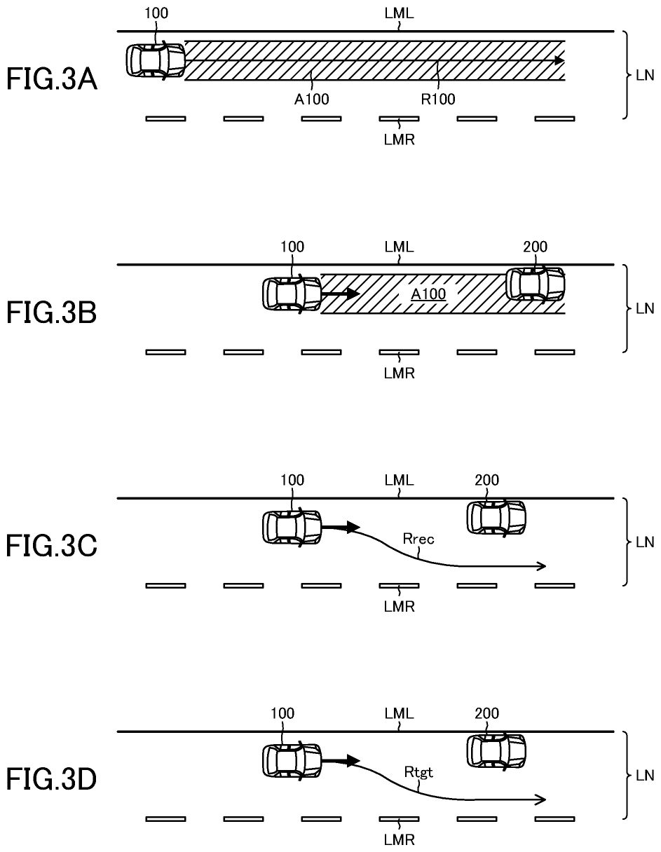

While the own vehicle 100 moves, the vehicle collision avoidance assist apparatus 10 determines, based on the forward information I_F, whether there is an object 200 in an own vehicle moving area A100. As shown in FIG. 3A, the own vehicle moving area A100 is an area which has (i) a center line corresponding to a moving route R100 of the own vehicle 100 and (ii) a width equal to the width of the own vehicle 100. The moving route R100 of the own vehicle 100 is a route along which the own vehicle 100 predictively moves assuming that the own vehicle 100 moves with maintaining the current steering angle SA.

When the vehicle collision avoidance assist apparatus 10 determines that there is the object 200 in the own vehicle moving area A100, the vehicle collision avoidance assist apparatus 10 acquires an object distance D200 and a relative moving speed dV. The object distance D200 is a distance between the object 200 and the own vehicle 100. The relative moving speed dV is a moving speed of the own vehicle 100 with respect to the object 200. Then, the vehicle collision avoidance assist apparatus 10 calculates and acquires a predicted reaching time TTC by dividing the object distance D200 by the relative moving speed dV (TTC=D200/dV). The predicted reaching time TTC is a time which the own vehicle 100 predictively takes to reach the object 200. While the vehicle collision avoidance assist apparatus 10 determines that there is the object 200 in the own vehicle moving area A100, the vehicle collision avoidance assist apparatus 10 acquires the predicted reaching time TTC with a predetermined calculation cycle CYC.

When the relative moving speed dV is constant, the predicted reaching time TTC decreases as the object distance D200 decreases. As shown in FIG. 3B, when the own vehicle 100 approaches the object 200, and the predicted reaching time TTC decreases to a predetermined time (this predetermined time will be hereinafter referred to as “predetermined predicted reaching time TTCth”), the vehicle collision avoidance assist apparatus 10 determines that a steering avoiding condition becomes satisfied. That is, when (i) the vehicle collision avoidance assist apparatus 10 acquires the predicted reaching time TTC as an index value which represents the probability that the own vehicle 100 collides with the object 200, and z(ii) the index value becomes equal to or greater than a predetermined index value, the vehicle collision avoidance assist apparatus 10 determines that the probability that the own vehicle 100 collides with the object has increased to a high level. Thus, in this embodiment, the index value which represents the probability that the own vehicle 100 collides with the object 200 increases as the predicted reaching time TTC decreases.

When the steering avoiding condition becomes satisfied, the vehicle collision avoidance assist apparatus 10 starts executing the steering avoidance control. When the vehicle collision avoidance assist apparatus 10 starts executing the steering avoidance control, the vehicle collision avoidance assist apparatus 10 determines whether the driver operates the steering wheel 33 so as to cause the own vehicle 100 to pass by the object 200.

When the vehicle collision avoidance assist apparatus 10 determines that the driver operates the steering wheel 33 so as to move the own vehicle 100 to avoid the object 200, as shown in FIG. 3C, the vehicle collision avoidance assist apparatus 10 sets a recommended avoidance route Rrec. The recommended avoidance route Rrec is a route recommended to move the own vehicle 100 to avoid the object 200.

In this embodiment, the vehicle collision avoidance assist apparatus 10 sets, as the recommended avoidance route Rrec, a route to move the own vehicle 100 in the own vehicle moving lane LN and avoid the object 200. In other words, the vehicle collision avoidance assist apparatus 10 sets, as the recommended avoidance route Rrec, a route to move the own vehicle 100 and avoid the object 200, preventing the own vehicle 100 from moving out of the own vehicle moving lane LN.

Further, in order to avoid the collision of the own vehicle 100 with the object 200 by forcibly steering the own vehicle 100 to move the own vehicle 100 along the recommended avoidance route Rrec, the vehicle collision avoidance assist apparatus 10 should set the recommended avoidance route Rrec, depending on the relative moving speed dV of the own vehicle 100 with respect to the object 200. Accordingly, the vehicle collision avoidance assist apparatus 10 is configured to set the recommended avoidance route Rrec in consideration of the relative moving speed dV of the own vehicle 100 with respect to the object 200.

Further, in this embodiment, the vehicle collision avoidance assist apparatus 10 sets the recommended avoidance route Rrec, depending on the operation applied to the steering wheel 33 by the driver. In particular, when the driver rotates the steering wheel 33 clockwise, the vehicle collision avoidance assist apparatus 10 sets, as the recommended avoidance route Rrec, a route passing the right side of the object 200. On the other hand, when the driver rotates the steering wheel 33 counterclockwise, the vehicle collision avoidance assist apparatus 10 sets, as the recommended avoidance route Rrec, a route passing the left side of the object 200.

After the vehicle collision avoidance assist apparatus 10 sets the recommended avoidance route Rrec, the vehicle collision avoidance assist apparatus 10 executes a process of steering the own vehicle 100 by increasing and decreasing the assist steering torque TQas, depending on the driver input torque TQdr so as to move the own vehicle 100 within a predetermined distance Dy from the recommended avoidance route Rrec. Hereinafter, this process of steering the own vehicle 100 will be referred to as “first avoiding steering process” or “assist steering process”. Thus, after the vehicle collision avoidance assist apparatus 10 sets the recommended avoidance route Rrec, the vehicle collision avoidance assist apparatus 10 executes the first avoiding steering process of controlling the assist steering torque TQas so as to move the own vehicle 100 within the predetermined distance Dy from the recommended avoidance route Rrec. Thus, the first avoiding steering process is realized by controlling the assist steering torque TQas in consideration of the driver input torque TQdr.

It should be noted that the vehicle collision avoidance assist apparatus 10 may be configured to decelerate the own vehicle 100 by decreasing the driving force applied to the own vehicle 100 or limiting the driving force applied to the own vehicle 100 to a certain value or less or applying the braking force to the own vehicle 100 in addition to executing the first avoiding steering process.

On the other hand, when the vehicle collision avoidance assist apparatus 10 determines that the driver does not operate the steering wheel 33 to cause the own vehicle 100 to avoid the object 200 when (i) the steering avoiding condition becomes satisfied, and (ii) the vehicle collision avoidance assist apparatus 10 starts executing the steering avoidance control, as shown in FIG. 3D, the vehicle collision avoidance assist apparatus 10 sets a target avoidance route Rtgt to move the own vehicle 100 to avoid the object 200.

In this embodiment, the vehicle collision avoidance assist apparatus 10 sets, as the target avoidance route Rtgt, a route to move the own vehicle 100 in the own vehicle moving lane LN and avoid the object 200. In other words, the vehicle collision avoidance assist apparatus 10 sets, as the target avoidance route Rtgt, a route to move the own vehicle 100 and avoid the object 200, preventing the own vehicle 100 from moving out of the own vehicle moving lane LN.

Further, in order to avoid the collision of the own vehicle 100 with the object 200 by forcibly steering the own vehicle 100 to move the own vehicle 100 along the target avoidance route Rtgt, the vehicle collision avoidance assist apparatus 10 should set the target avoidance route Rtgt, depending on the relative moving speed dV of the own vehicle 100 with respect to the object 200. Accordingly, the vehicle collision avoidance assist apparatus 10 is configured to set the target avoidance route Rtgt in consideration of the relative moving speed dV of the own vehicle 100 with respect to the object 200.

After the vehicle collision avoidance assist apparatus 10 sets the target avoidance route Rtgt, the vehicle collision avoidance assist apparatus 10 executes a process of steering the own vehicle 100 by controlling the assist steering torque TQas to move the own vehicle 100 along the target avoidance route Rtgt. Hereinafter, this process of steering the own vehicle 100 will be referred to as “second avoiding steering process” or “autonomous steering process”. Thus, the second avoiding steering process is realized by controlling the assist steering torque TQas without considering the driver input torque TQdr.

It should be noted that the vehicle collision avoidance assist apparatus 10 may be configured to decelerate the own vehicle 100 by decreasing the driving force applied to the own vehicle 100 or limiting the driving force applied to the own vehicle 100 to a certain value or less or applying the braking force to the own vehicle 100 in addition to executing the second avoiding steering process.

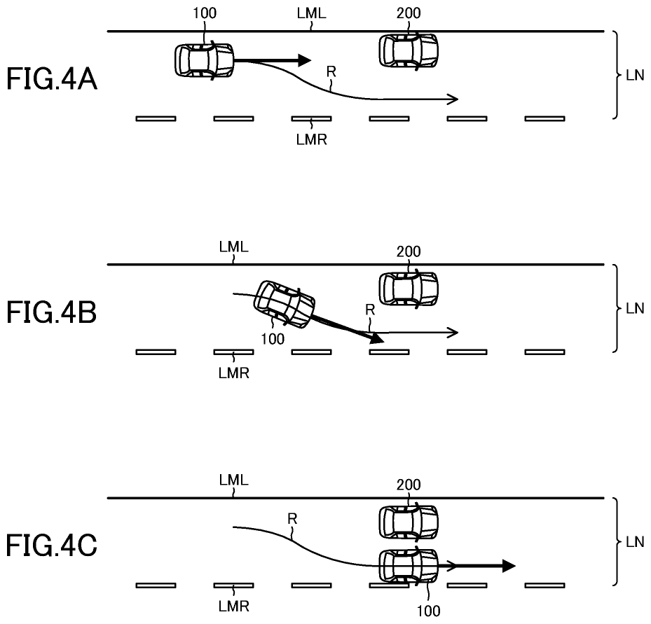

When (i) the avoidance route R (i.e., the recommended avoidance route Rrec or the target avoidance route Rtgt) is set as shown in FIG. 4A, and (ii) an execution of the avoiding steering process (i.e., the first avoiding steering process or the second avoiding steering process) is started, the own vehicle 100 is steered to move along the avoidance route R as shown in FIG. 4B, and avoids the collision with the object 200 as shown in FIG. 4C.

It should be noted that the vehicle collision avoidance assist apparatus 10 does not execute the avoiding steering process (i.e., the first avoiding steering process or the second avoiding steering process) when (i) the width of the own vehicle moving lane LN is narrow and thus, there is no space to move the own vehicle 100 to avoid the object 200 at the side of the object 200 and thus, (ii) the vehicle collision avoidance assist apparatus 10 cannot set the recommended avoidance route Rrec or the target avoidance route Rtgt. Also, the vehicle collision avoidance assist apparatus 10 does not execute the avoiding steering process (i.e., the first avoiding steering process or the second avoiding steering process) when (i) the vehicle collision avoidance assist apparatus 10 does not recognize the left lane marking LML at the left side of the own vehicle 100 or the right lane marking LMR at the right side of the own vehicle 100 and thus, (ii) the vehicle collision avoidance assist apparatus 10 cannot set the recommended avoidance route Rrec or the target avoidance route Rtgt. That is, when a forbidding condition that the recommended avoidance route Rrec or the target avoidance route Rtgt cannot be set, is satisfied, the vehicle collision avoidance assist apparatus 10 does not execute the avoiding steering process.

It should be noted that one or more of conditions C1 to C21 below may be used as the forbidding condition.

A condition C1 is a condition that the vehicle collision avoidance assist apparatus 10 cannot realize the avoiding steering process (the first avoiding steering process of the second avoiding steering process) due to a fact that devices such as the steering apparatus 23 used to realize the avoiding steering process are malfunctioned.

A condition C2 is a condition that when the vehicle collision avoidance assist apparatus 10 is configured to execute an autonomous brake control (PCS), the vehicle collision avoidance assist apparatus 10 cannot realize the autonomous brake control due to a fact that devices such as the braking apparatus 22 used to realize the autonomous brake control are malfunctioned. The autonomous brake control is a control of stopping the own vehicle 100 by forcibly braking the own vehicle 100 before the own vehicle 100 collides with the object ahead of the own vehicle 100 when the probability that the own vehicle 100 collides with the object ahead of the own vehicle 100 has increased to a high level.

A condition C3 is a condition that when the vehicle collision avoidance assist apparatus 10 is configured to execute a sideslip prevention control (VSC), the vehicle collision avoidance assist apparatus 10 cannot realize the sideslip prevention control due to a fact that devices such as the braking apparatus 22 used to realize the sideslip prevention control are malfunctioned. The sideslip prevention control is, for example, a control of stabilizing a moving behavior of the own vehicle 100 by adjusting the driving force PD applied to the own vehicle 100 or individually adjusting the braking forces PB applied to wheels of the own vehicle 100, respectively when the moving behavior of the own vehicle 100 becomes unstable due to steering the own vehicle 100.

A condition C4 is a condition that when the vehicle collision avoidance assist apparatus 10 is configured to execute the autonomous brake control (PCS), the vehicle collision avoidance assist apparatus 10 can stop the own vehicle 100 by the autonomous brake control before the own vehicle 100 collides with the object 200.

A condition C5 is a condition that when (i) the vehicle collision avoidance assist apparatus 10 is configured to execute the autonomous brake control (PCS), and (ii) the vehicle collision avoidance assist apparatus 10 starts executing the autonomous brake control and then, terminates executing the autonomous brake control, a time elapsing since the vehicle collision avoidance assist apparatus 10 terminates executing the autonomous brake control is equal to or shorter than a predetermined time.

A condition C6 is a condition that when the vehicle collision avoidance assist apparatus 10 starts executing the steering avoidance control and then, the vehicle collision avoidance assist apparatus 10 terminates executing the steering avoidance control, a time elapsing since the vehicle collision avoidance assist apparatus 10 terminates executing the steering avoidance control is equal to or shorter than a predetermined time.

A condition C7 is a condition that the vehicle collision avoidance assist apparatus 10 activates or blinks turn signals of the own vehicle 100.

A condition C8 is a condition that when (i) the object 200 is a preceding vehicle, and (ii) the recommended avoidance route Rrec or the target avoidance route Rtgt is a route passing at the left side of the preceding vehicle, left turn signals of the preceding vehicle are activated or blinked. The vehicle collision avoidance assist apparatus 10 can determine, based on the forward information I_F, whether the left turn signals of the preceding vehicle are activated or blinked. It should be noted that the preceding vehicle is a vehicle which moves ahead of the own vehicle 100 in the own vehicle moving lane LN or the moving lane of the own vehicle 100 in the same direction as the moving direction of the own vehicle 100.

A condition C9 is a condition that when (i) the object 200 is the preceding vehicle, and (ii) the recommended avoidance route Rrec or the target avoidance route Rtgt is a route passing at the right side of the preceding vehicle, right turn signals of the preceding vehicle are activated or blinked. The vehicle collision avoidance assist apparatus 10 can determine, based on the forward information I_F, whether the right turn signals of the preceding vehicle are activated or blinked.

A condition C10 is a condition that the accelerator pedal operation amount AP is equal to or greater than a predetermined accelerator pedal operation amount APth.

A condition C11 is a condition that the brake pedal operation amount BP is equal to or greater than a predetermined brake pedal operation amount BPth.

A condition C12 is a condition that the vehicle moving speed V100 of the own vehicle 100 is not within a predetermined range Rv.

A condition C13 is a condition that the relative moving speed dV of the object 200 with respect to the own vehicle 100 is not within a predetermined range Rdv.

A condition C14 is a condition that the lateral acceleration Gy is equal to or greater than a predetermined lateral acceleration Gy_th.

A condition C15 is a condition that the longitudinal acceleration Gx is a positive value, and an absolute value of the longitudinal acceleration Gx is equal to or greater than a predetermined value Gx_th.

A condition C16 is a condition that the longitudinal acceleration Gx is a negative value, and the absolute value of the longitudinal acceleration Gx is equal to or greater than the predetermined value Gx_th.

A condition C17 is a condition that the own vehicle 100 moves along a curving road. The vehicle collision avoidance assist apparatus 10 can determine, based on the forward information I_F, whether the own vehicle 100 moves along the curving road.

A condition C18 is a condition that a lane-markings distance is equal to or longer than a predetermined distance. The lane-markings distance is a distance between the left lane marking LML at the left side of the own vehicle 100 and the right lane marking LMR at the right side of the own vehicle 100. The vehicle collision avoidance assist apparatus 10 can acquire the lane-markings distance, based on the forward information I_F.

A condition C19 is a condition that the recommended avoidance route Rrec or the target avoidance route Rtgt crosses a longitudinally-extending center line of the object 200. The vehicle collision avoidance assist apparatus 10 can determine, based on the forward information I_F, whether the recommended avoidance route Rrec or the target avoidance route Rtgt crosses the longitudinally-extending center line of the object 200.

A condition C20 is a condition that the object 200 moves, crossing the recommended avoidance route Rrec or the target avoidance route Rtgt. The vehicle collision avoidance assist apparatus 10 can determine, based on the forward information I_F, whether the object 200 moves, crossing the recommended avoidance route Rrec or the target avoidance route Rtgt.

A condition C21 is a condition that the vehicle collision avoidance assist apparatus 10 can set the recommended avoidance route Rrec or the target avoidance route Rtgt but the vehicle collision avoidance assist apparatus 10 predicts that the vehicle collision avoidance assist apparatus 10 cannot move the own vehicle 100 along the recommended avoidance route Rrec or the target avoidance route Rtgt.

<Termination of Execution of Steering Avoidance Control>

After the vehicle collision avoidance assist apparatus 10 starts executing the avoiding steering process (i.e., the first avoiding steering process or the second avoiding steering process), the vehicle collision avoidance assist apparatus 10 monitors whether a terminating condition becomes satisfied. The terminating condition is a condition that an absolute value of the yaw angle YA becomes equal to or smaller than a predetermined yaw angle YAth. The vehicle collision avoidance assist apparatus 10 continues executing the avoiding steering process (i.e., the first avoiding steering process or the second avoiding steering process) as far as the terminating condition is not satisfied. On the other hand, when the terminating condition becomes satisfied, the vehicle collision avoidance assist apparatus 10 terminates executing the avoiding steering process or the steering avoidance control.

It should be noted that when the vehicle collision avoidance assist apparatus 10 is configured to execute the steering avoidance control and brake and stop the own vehicle 100, the vehicle collision avoidance assist apparatus 10 may be configured to terminate executing the steering avoidance control or the avoiding steering process when the own vehicle 100 stops.

<Stop of Execution of Steering Avoidance Control>

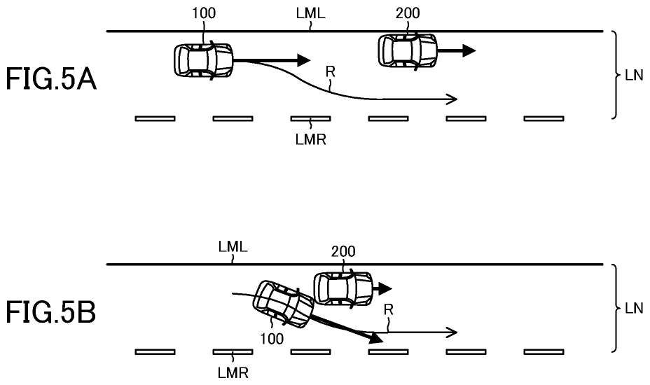

The object 200 with which the steering avoidance control avoids the collision of the own vehicle 100, may be an object such as the preceding vehicle which moves in the same direction as the moving direction of the own vehicle 100. Hereinafter, the object 200 with which the steering avoidance control avoids the collision of the own vehicle 100, will be referred to as “target object 200tgt”. Further, the target object 200tgt which moves in the same direction as the moving direction of the own vehicle 100, will be referred to as “target moving object 200Mtgt”. In this case, if (i) the vehicle collision avoidance assist apparatus 10 sets the avoidance route R (i.e., the recommended avoidance route Rrec or the target avoidance route Rtgt) as shown in FIG. 5A and starts executing the avoiding steering process (i.e., the first avoiding steering process or the second avoiding steering process), and then (ii) the target moving object 200Mtgt is decelerated, the own vehicle 100 may rapidly approach the target moving object 200Mtgt, and the avoidance route R becomes close to or crosses the target moving object 200Mtgt. For example, as shown in FIG. 5B, if the avoiding steering process continues being executed when the own vehicle 100 rapidly approaches the target moving object 200Mtgt, and the avoidance route R becomes close to or crosses the target moving object 200Mtgt, the own vehicle 100 may collides with the target moving object 200Mtgt.

Accordingly, when the target object 200tgt is a moving object 200M or the target moving object 200Mtgt, the vehicle collision avoidance assist apparatus 10 acquires a deceleration GxM of the target moving object 200Mtgt, based on the forward information I_F after the vehicle collision avoidance assist apparatus 10 starts executing the avoiding steering process (i.e., the first avoiding steering process or the second avoiding steering process). Then, the vehicle collision avoidance assist apparatus 10 stops executing the steering avoidance control when the deceleration GxM becomes equal to or greater than a predetermined deceleration GxMth.

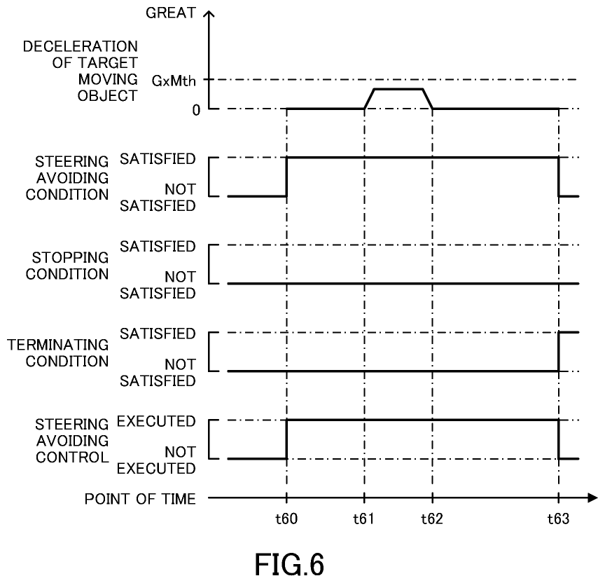

Thus, if the deceleration GxM of the target moving object 200Mtgt does not becomes equal to or greater than the predetermined deceleration GxMth before the terminating condition becomes satisfied after the vehicle collision avoidance assist apparatus 10 starts executing the avoiding steering process, the vehicle collision avoidance assist apparatus 10 terminates executing the steering avoidance control when the terminating condition becomes satisfied as shown in FIG. 6.

In an example shown in FIG. 6, at a point of time t60, the steering avoiding condition becomes satisfied, and the execution of the steering avoidance control is started. Then, at a point of time t61, the deceleration GxM of the target moving object 200Mtgt starts to increase. Then, at a point of time t62, the deceleration GxM of the target moving object 200Mtgt becomes zero. However, the deceleration GxM of the target moving object 200Mtgt does not become equal to or greater than the predetermined deceleration GxMth. Thus, the execution of the steering avoidance control is continued. Then, at a point of time t63, the terminating condition becomes satisfied. Thus, the execution of the steering avoidance control is terminated.

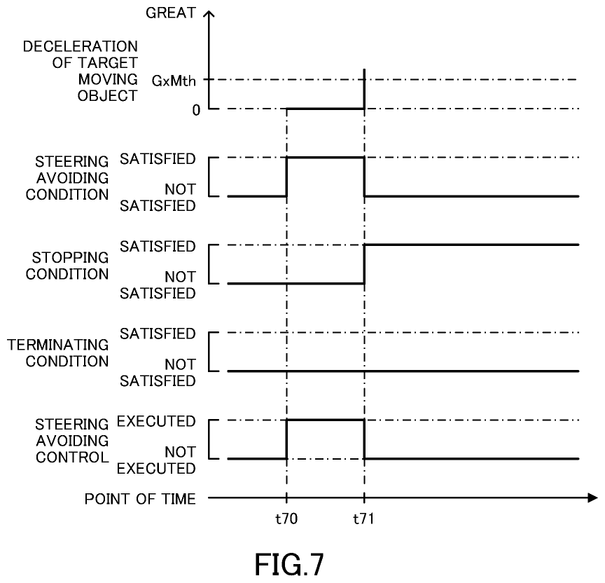

On the other hand, when the deceleration GxM of the target moving object 200Mtgt becomes equal to or greater than the predetermined deceleration GxMth before the terminating condition becomes satisfied, the vehicle collision avoidance assist apparatus 10 stops executing the steering avoidance control as shown in FIG. 7. That is, when a stopping condition that the deceleration GxM of the target moving object 200Mtgt becomes equal to or greater than the predetermined deceleration GxMth before the terminating condition becomes satisfied, becomes satisfied, the vehicle collision avoidance assist apparatus 10 stops executing the steering avoidance control.

In an example shown in FIG. 7, at a point of time t70, the steering avoiding condition becomes satisfied. Thus, the execution of the steering avoidance control is started. Then, at a point of time t71, the deceleration GxM of the target moving object 200Mtgt becomes equal to or greater than the predetermined deceleration GxMth. Thus, the stopping condition becomes satisfied. Thus, the execution of the steering avoidance control is stopped.

As described above, when the moving object 200M with which the steering avoidance control avoids the collision of the own vehicle 100, is decelerated, i.e., the target moving object 200Mtgt is decelerated, the own vehicle 100 may rapidly approach the target moving object 200Mtgt, and the avoidance route R may become close to or cross the target moving object 200Mtgt. If the execution of the steering avoidance control is continued after the own vehicle 100 rapidly approaches the target moving object 200Mtgt, and the avoidance route R becomes close to or cross the target moving object 200Mtgt, the own vehicle 100 may collide with the target moving object 200Mtgt. According to the vehicle collision avoidance assist apparatus 10, the execution of the steering avoidance control is stopped when (i) the target moving object 200Mtgt is decelerated while the steering avoidance control is being executed, and (ii) the deceleration GxM of the target moving object 200Mtgt becomes equal to or greater than the predetermined deceleration GxMth. Thus, the own vehicle 100 can be prevented from colliding with the target moving object 200Mtgt due to the deceleration of the target moving object 200Mtgt.

It should be noted that the vehicle collision avoidance assist apparatus 10 may be configured to stop executing the steering avoidance control when the driver input torque TQdr becomes equal to or greater than a relatively great predetermined torque TQth while the vehicle collision avoidance assist apparatus 10 executes the steering avoidance control.

<Specific Operations of Vehicle Collision Avoidance Assist Apparatus>

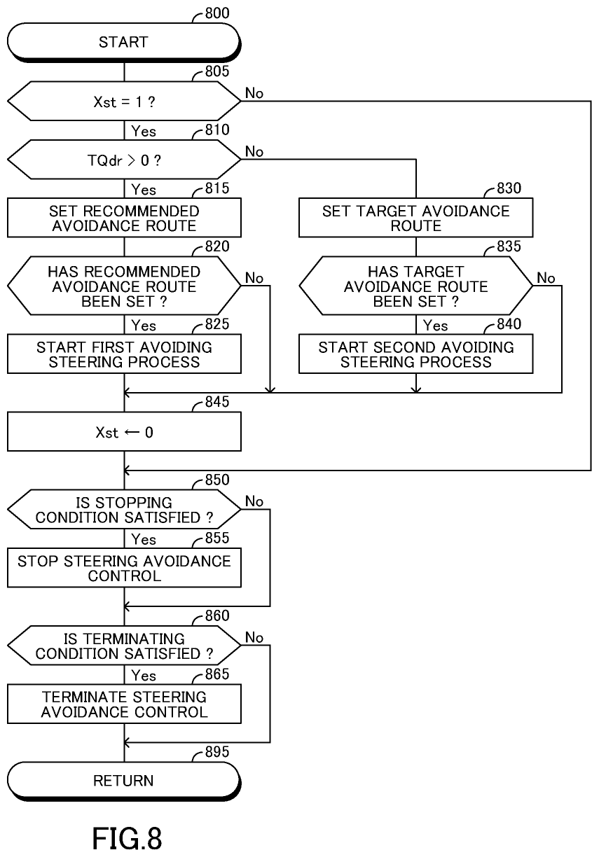

Next, specific operations of the vehicle collision avoidance assist apparatus 10 will be described. The CPU of the ECU 90 of the vehicle collision avoidance assist apparatus 10 is configured or programmed to execute a routine shown in FIG. 8 each time a predetermined time elapses. Thus, at a predetermined timing, the CPU starts executing a process from a step 800 of the routine shown in FIG. 8 and proceeds with the process to a step 805 to determine whether a value of a steering avoiding condition flag Xst is “1”. The value of the steering avoiding condition flag Xst is set to “1” when the steering avoiding condition becomes satisfied.

When the CPU determines “Yes” at the step 805, the CPU proceeds with the process to a step 810 to determine whether the driver input torque TQdr is greater than zero. When the CPU determines “Yes” at the step 810, the CPU proceeds with the process to a step 815 to set the recommended avoidance route Rrec. Then, the CPU proceeds with the process to a step 820 to determine whether the CPU has set the recommended avoidance route Rrec.

When the CPU determines “Yes” at the step 820, the CPU proceeds with the process to a step 825 to start executing the first avoiding steering process. Then, the CPU proceeds with the process to a step 845. On the other hand, when the CPU determines “No” at the step 820, the CPU proceeds with the process directly to the step 845. In this case, the execution of the first avoiding steering process is not started.

Further, when the CPU determines “No” at the step 810, the CPU proceeds with the process to a step 830 to set the target avoidance route Rtgt. Then, the CPU proceeds with the process to a step 835 to determine whether the CPU has set the target avoidance route Rtgt. When the CPU determines “Yes” at the step 835, the CPU proceeds with the process to a step 840 to start executing the second avoiding steering process. Then, the CPU proceeds with the process to the step 845. On the other hand, when the CPU determines “No” at the step 835, the CPU proceeds with the process directly to the step 845. In this case, the execution of the second avoiding steering process is not started.

When the CPU proceeds with the process to the step 845, the CPU sets the value of the steering avoiding condition flag Xst to “0”. Then, the CPU proceeds with the process to a step 850.

Further, when the CPU determines “No” at the step 805, the CPU proceeds with the process directly to the step 850.

When the CPU proceeds with the process to the step 850, the CPU determines whether the stopping condition becomes satisfied. When the CPU determines “Yes” at the step 850, the CPU proceeds with the process to a step 855. At the step 855, when the CPU executes the avoiding steering process (i.e., the first avoiding steering process or the second avoiding steering process), the CPU stops executing the steering avoidance control by stopping executing the avoiding steering process. Then, the CPU proceeds with the process to a step 860. On the other hand, when the CPU determines “No” at the step 850, the CPU proceeds with the process directly to the step 860. At this time, when the CPU executes the avoiding steering process (i.e., the first avoiding steering process or the second avoiding steering process), the CPU continues executing the avoiding steering process.

When the CPU proceeds with the process to the step 860, the CPU determines whether the terminating condition becomes satisfied. When the CPU determines “Yes” at the step 860, the CPU proceeds with the process to a step 865. At the step 865, when the CPU executes the avoiding steering process (i.e., the first avoiding steering process or the second avoiding steering process), the CPU terminates executing the steering avoidance control by terminating executing the avoiding steering process. Then, the CPU proceeds with the process to a step 895 to terminate executing the process of this routine once. On the other hand, when the CPU determines “No” at the step 860, the CPU proceeds with the process directly to the step 895 to terminate executing the process of this routine once. At this time, when the avoiding steering process (i.e., the first avoiding steering process or the second avoiding steering process) is executed, the execution of the avoiding steering process is continued.

The specific operations of the vehicle collision avoidance assist apparatus 10 have been described.

It should be noted that the invention is not limited to the aforementioned embodiments, and various modifications can be employed within the scope of the invention.

What is claimed is:

1. A vehicle collision avoidance assist apparatus, comprising an electronic control unit configured to execute a steering avoidance control of:
when an index value representing a probability of collision of an own vehicle with an object ahead of the own vehicle becomes equal to or greater than a predetermined index value, setting an avoidance route for avoiding the collision of the own vehicle with the object in a lane in which the own vehicle moves; and
executing an avoiding steering process of forcibly steering the own vehicle so as to move the own vehicle along the avoidance route,
wherein the electronic control unit is configured to stop executing the steering avoidance control when (i) the object is a moving object which moves in the same direction as a moving direction of the own vehicle, and (ii) a deceleration of the moving object becomes equal to or greater than a predetermined deceleration.

2. The vehicle collision avoidance assist apparatus as set forth in claim 1, wherein the avoidance route is set, based on a relative moving speed of the own vehicle with respect to the moving object at a point of time when the index value becomes equal to or greater than the predetermined index value.

3. The vehicle collision avoidance assist apparatus as set forth in claim 1,
wherein the index value is a predicted reaching time which is a time predictively taken for the own vehicle to reach the object,
wherein the index value increases as the predicted reaching time decreases,
wherein the predicted reaching time is acquired, based on (i) a distance between the own vehicle and the object and (ii) a relative moving speed of the own vehicle with respect to the object, and
wherein the steering avoidance control is executed when the predicted reaching time becomes a predetermined predicted reaching time which corresponds to the predetermined index value.
